(19) United States
(12) Patent Application Publication
(10) Pub. No.: US 2009/0074938 A1
(43) Pub. Date: Mar. 19, 2009

(54) Nutraceutical preparation that improved weight gain, feed efficiency and reduced mortality in animals

(75) Inventor: Reuben D. Walker, Naperville, IL (US)

Correspondence Address: Reuben D. Walker, 1039 Knoll Dr., Naperville, IL, 60565, US

(73) Assignee: Performance Plus International Inc., Naperville, IL (US)

(21) Appl. No.: 12/218,354

(22) Filed: Jul. 16, 2008

(30) Foreign Application Priority Data
Sep. 13, 2007 (CA) 2597371

(51) Int. Cl. A23K 1/14; A23K 1/00

(52) U.S. Cl. 426/635; 426/648

(57) ABSTRACT

Nutraceutical preparations of Trigonella foenum-graceum L useful in improving the weight gain, feed efficiency and reducing mortality in animals, when administered in the diet or drinking water.

### BACKGROUND OF THE INVENTION

This invention relates to the use of Trigonella foenum-graceum L. in the feed or water of animals to improve their weight gain, feed efficiency, dry matter digestibility, amino acid digestibility, lysine availability, methinone availability, methinone+cystine availability and reduce mortality. The rate of weight gain, amount of feed required to produce a unit of body weight gain (feed efficiency) and the mortality of animals are important economic parameters in commercial production of food animals.

Trigonella foenum-graecum L. is a self-pollinated, small-seeded annual legume (family Leguminosae) that is closely related to alfalfa and is cultivated as a spice and forage crop. It is widely cultivated in warm temperate and tropical regions in the Mediterranean, Europe and Asia. The major seed producing countries are India, Ethiopia, Egypt and Turkey. In India, the seeds are used in curries, dyes and young seedlings are often eaten as a vegetable. In Europe and North America the seed is used as a spice, an imitation maple, vanilla, rum or butterscotch flavoring.

### DISCLOSURE OF THE INVENTION

As a result of extensive research with natural plant materials the inventor has attained the following unexpected invention. Trigonella foenum-graecum L. when fed to animals at significantly greater doses than used in human cooking as a spice or flavoring agent, it was discovered to significantly increase the weight gain, improve the feed efficiency and reduce mortality of food producing animals.

This invention is further illustrated by the following examples, which are not construed as imposing any limitation on the scope thereof. On the contrary, it is to be clearly that resort may be had various embodiments, modifications and equivalents thereof which readily suggest themselves to those skilled in the art without departing from the spirit of the present invention and/or the scope of the appended claims.

### EXAMPLE 1

A forty-two (42) day broiler study was conducted with five hundred (500) commercial Cobb X Cobb strain broiler chicks, allotted to ten (10) pens containing fifty (50) chicks per pen. Five (5) pens were randomly assigned to both the control and the Trigonella foenum-graecum L. treatment. A basal control diet was formulated to be representative of diets used by commercial broiler producers. Ground Trigonella foenum-graecum L. seed was added to the basal control diet at the rate of 800 grams per metric ton of complete feed. Chicks received water and feed ad libitum throughout the study. The study was conducted in three phases using the standard feeding program of a major United States broiler producer. The anticoccidial drug Salinomycin, for the prevention of coccidiosis, was included in the basal and experimental starter diets at 40 grams per metric ton, basal and experimental grower diets at 50 grams per metric ton and the basal and experimental finishing diets at 40 grams per metric ton, according the standard commercial feeding program and the drug manufacturer's recommendations.

Boriler Performance Data - 42 Days

| Treatment | Control | Trigonell foenum-graecum L. |
|---|---|---|
| Weight, g | 2449.0 a | 2505.6 b |
| Feed/Gain | 1.8234 c | 1.7840 d |
| Mortality, % | 4.40 | 3.20 |

a, b P = 0.085
c, d P = 0.052
Trigonella foenum-graecum L. significantly increased weight gain (+56.6 grams, +2.31%) and improved feed efficiency (−0.0394, −2.16%). Mortality was reduced by −0 . . . 8 percentage points (−18.2%).

The synthesis of tissue during growth of an animal requires nutrients be available for synthesis in a specific ratio. The nutrient having the lowest supply relative to its required ratio to other essential nutrients limits tissue synthesis (growth or weight gain). This nutrient is term the first limiting for growth. The term is most frequently applied to the essential amino acids. In the case of broiler chicks in Example 1, lysine is the first limiting amino acid, with methinone being the second limiting. As a result of molecular structure cystine can replace a portion of the required methionine, therefore the total amount of methionine+cystine is an important quality factor in broiler diets.

The availability of amino acids from a diet can be calculated by linear regression of the grams intake of an amino acid against the grams of weight gain. The regression coefficient or regression slope provides a measure of the availability of the amino acid from the test diet.

Amino Acid Digestibility/Availability
Regression Slopes

| | | Trigonella foenum- | |
|---|---|---|---|
| Amino Acid | Control | graecum L. | Difference, % |
| Lysine | 66.30833 | 65.59101 | +3.44 |
| Methionine | 124.65616 | 129.08114 | +3.55 |
| Meth + Cystine | 74.76643 | 77.34154 | +3.44 |

Trigonella foenum-graecum L. increased the digestibility/availability of lysine (+3.44%), methionine (+3.55%) and methionine + cystine (+3.44%).

On the basis of the above results, it is obvious that Trigonella foenum-graecum L. is significantly improves weight gain, feed efficiency, dry matter digestability, amino acid availability, lysine availability, methionine availability, methionine+cystine availability and reduces mortality in animals.

What is claimed is:

1. A nutraceutical preparation containing 50 grams to 2,000 grams, preferably 500 to 1,000 grams, of Trigonella foemum-graecum L. per metric ton of complete animal feed.

2. An animal feed additive that increases body weight gain in commercial food producing animals.

3. An animal feed additive that improves feed efficiency in commercial food producing animals.

4. An animal feed additive that increases dry digestibility in commercial food producing animals.

5. An animal feed additive that increases amino acid digestibility/availability in commercial food producing animals.

6. An animal feed additive that increases lysine digestibility/availability in commercial food producing animals.

7. An animal feed additive that increases methionine digestibility/availability in commercial food producing animals.

8. An animal feed additive that increases methionine+cystine digestibility/availability in commercial food producing animals.

9. An animal feed additive that decreases mortality in commercial food producing animals.
